(19) United States
(12) Patent Application Publication
(10) Pub. No.: US 2004/0243465 A1
(43) Pub. Date: Dec. 2, 2004

(54) Method of administering a reward scheme

(76) Inventor: Edward Preston Manners, Ourimbah New South Wales (AU)

Correspondence Address: NIXON & VANDERHYE, PC, 1100 N GLEBE ROAD, 8TH FLOOR, ARLINGTON, VA, 22201-4714, US

(21) Appl. No.: 10/488,507

(22) PCT Filed: Jul. 31, 2002
(86) PCT No.: PCT/AU02/01015

(30) Foreign Application Priority Data
Sep. 3, 2001 (AU) PR 7455
Jan. 20, 2002 (AU) PS 0201

(51) Int. Cl. G06F 17/60

(52) U.S. Cl. 705/14; 705/39

(57) ABSTRACT

A method of administering a rewards scheme, including the steps of: receiving a plurality of Electronic Extract Reports (EERs) corresponding to a plurality of eligible transactions, each eligible transaction being a purchase transaction effected using an electronic transaction terminal between a business member of the rewards scheme and a customer member of the rewards scheme; identifying from the EERs the business member and customer member party to each eligible transaction and a cash amount associated with the eligible transaction; obtaining a credit from the business member for a predetermined percentage of the cash amount of each eligible transaction; providing a first portion of the credit to the customer member party to the eligible transaction for which the credit was obtained; and using a second portion of the credit to fund advertisement in favour of the business member.

### FIELD OF THE INVENTION

The present invention relates to a method of administering a rewards scheme and, in particular, a method of administering a rewards scheme wherein customer members of the scheme can become eligible to receive bonus rewards for particular purchases.

### BACKGROUND OF THE INVENTION

Customer loyalty rewards schemes are used in a number of ways to encourage customers to purchase a particular service or product from a particular retailer or provider. For example, an airline may provide frequent flyer points to those customers which use its airline services and, once a certain number of frequent flyer points is accumulated, the customer can redeem those points for a reward. In this case, the reward is usually a free flight or an upgrade from economy class to a higher quality ticket. Also, credit card issuers offer loyalty rewards points to consumers who use that credit card for their purchases. Once a certain number of reward points are accumulated, the customer can elect to redeem those points in exchange for a service or product offered by the card issuer. These schemes do not normally allow the customer to redeem the rewards points for a cash value but instead provide an in-kind reward or a product or service selected out of a catalogue provided by the card issuer.

Some loyalty reward schemes allow for bonus rewards to be earned by the customer when that customer uses the service of, or purchases products from, a particular retailer or service provider. For example, the Diners Club Card provides bonus points to its card members when those card members purchase car rental from a particular car rental company, for example such as Hertz or Avis. In this way, the Diners Club rewards scheme offers particular incentives to card members when they use the services of a business member which is also registered with the scheme. Use of the Diners Club Card with businesses that are not part of the bonus rewards scheme does not accrue bonus points for the card member.

### SUMMARY OF THE INVENTION

The present invention provides a method of administering a rewards scheme, including the steps of:

receiving a plurality of Electronic Extract Reports (EERs) corresponding to a plurality of eligible transactions, each eligible transaction being a purchase transaction effected using an electronic transaction terminal between a business member of the rewards scheme and a customer member of the rewards scheme,

identifying from the EERs the business member and customer member party to each eligible transaction and a cash amount associated with the eligible transaction;

obtaining a credit from the business member for a predetermined percentage of the cash amount of each eligible transaction;

providing a first portion of the credit to the customer member party to the eligible transaction for which the credit was obtained; and

advertising in favour of the business member in a periodical publication associated with a confined geographic area, using a second portion of the credit.

Preferably, the method further includes the step of retaining a third portion of the credit as a commission payable to an administrator of the reward scheme. Preferably, the proportions of the first, second, and third portions of the credit are 7:1:2, respectively. Preferably, the method further includes the step of advertising in favour of the business member in a periodical publication associated with the administrator. The periodical publication may be in the form of hard copy publication, for example a newspaper, or a publication available electronically, for example a news and advertising service provided over the Internet.

Advantageously, each business member is selected to have a specific degree of market exclusivity, and/or a specific market territory.

The combination of a loyalty reward program in conjunction with “call to order” price-product advertising on a regular basis in local community media (newspapers, on-line news media and other periodical publications), with each business member having a degree of exclusivity either in terms of the market and/or in terms of territory, can provide the business member with a substantial market advantage, thus making it worthwhile to give the customer a much higher reward when compared with other reward programs.

Typically, the predetermined percentage is 5% of the purchase price of the good or service and the first, second and third portions are 3.5%, 0.5% and 1%. However, depending on the nature of the transaction, the predetermined percentage may be reduced to as low as 1% while retaining a similar proportional division of the cash amount amongst the first and second portions but not necessarily between the second and third portions. This may be the case for grocery purchases, for example, where the retailer has a small profit margin. For certain transactions, for example admission to tourist attractions or sale of movie tickets, it may be possible to increase the percentage, for example up to 20%, while retaining the 7:1:2 or similar proportions (eg. 7:1.2:1.8)

Preferably, each customer member has a membership number associated with a credit or debit card for effecting the purchase transaction in combination with the electronic transaction terminal. Preferably, each electronic transaction terminal has a unique identification number or unique merchant description associated with a business member. Preferably, the steps of the method are carried out by the administrator of the rewards scheme and the periodical publication associated with the administrator is directed to a population including customer members of the rewards scheme.

In one aspect, the invention provides a system adapted to perform the above-described method. In another aspect, the invention also provides computer program instructions for causing a computer system to perform the above-described method.

The specific hardware and/or software by which capture of the EERs is effected following a purchase transaction does not form part of this invention.

Advantageously, the rewards scheme of a preferred embodiment of the invention effectively provides a cash rebate to the consumer while encouraging that consumer to shop at a particular retailer or service provider who is one of a limited number of members of the loyalty rewards scheme, thereby providing that retailer or service provider with a significant market advantage with respect to its competitors in that locality. The business members are advantageously selected to participate in the reward program to satisfy the consumer spending demographic to which the advertising of the periodical publication is directed and, alternatively, to broaden the appeal of the rewards scheme to more consumers. Further advantageously, the retailer or service provider receives advertising services in its favour as part of the promotion of the loyalty scheme and in particular can offer further “specials” through this advertising to attract non-member customers as well as members of the loyalty rewards scheme, This advertising is administered by the administrator of the reward scheme and requires minimal input from the retailer or service provider except to notify the administrator of particular “specials” which it may wish to advertise.

Advantageously, customer and business members of the rewards scheme are not charged joining fees, thereby providing a suitably low barrier to participation in the scheme.

A further advantage is derived from the low cost of automatic data collection for each of the eligible transactions through the use of magnetic strip cards (commonly issued by banks) or other similar cards together with the various point-of-sale devices for effecting electronic funds transfer. Because the infrastructure for such data collection is installed by retailers and other third parties, it is only necessary for the administrator of the rewards scheme to receive a data output (either electronic or hard copy) of the eligible transactions derived from the EERs

A further advantage of the present loyalty rewards program lies in the provision of a reward to the customer member within a short time, such as a month, in the form of a cash. rebate. This is important as loyalty programs having more apparent short term benefits are proven to be more successful than loyalty programs having benefits which only accrue over a longer term.

A still further advantage of the invention lies in the powerful marketing position of the rewards program derived from the combination of the passive pulling power of a loyalty rewards scheme with the “call to order” price-product pulling power of large volume regular advertising in community periodicals. Examples of “call to order” advertising include promotions such as “This special offer ends this Sunday at 5 pm” or “Available to use at this Sunday's rugby match between club A and club B”.

### BRIEF DESCRIPTION OF THE DRAWINGS

FIG. 1 is a schematic diagram of the relationship between members and retailers (or service providers) enrolled in the rewards scheme,

FIG. 2 is a block diagram of an administration system according to an embodiment of the invention for administering a rewards scheme; and

FIG. 3 is a block diagram of a method according to an embodiment of the invention for administering a rewards scheme.

A preferred embodiment of the present invention is described in detail hereinafter, by way of example only, with reference to the accompanying drawings.

### DETAILED DESCRIPTION OF THE PREFERRED EMBODIMENT

One or more embodiments of the present invention may be used in conjunction with methods of direct marketing. For example, a (customer) member information database developed as a result of using the method of the present invention may be used as an input to the method and system for direct marketing described in the above referenced application.

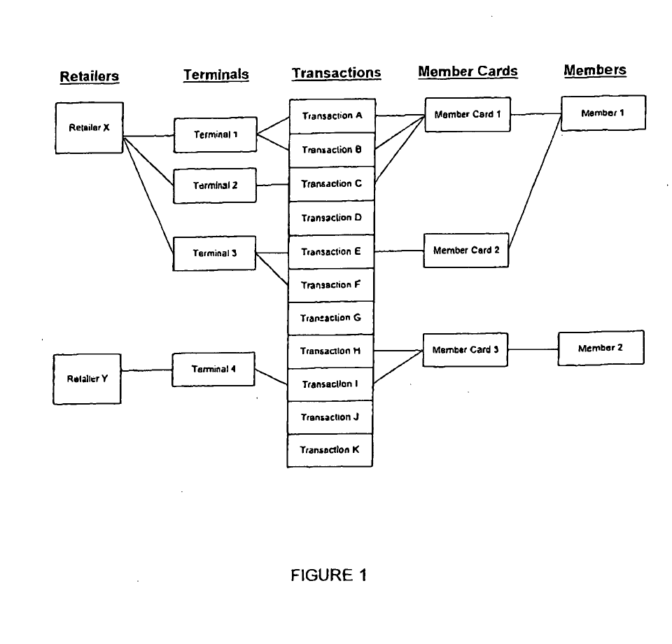

Referring to FIG. 1, a series of transactions A to K may be conducted using particular electronic transaction terminals and valid encoded cards which can be read by those terminals. Under the scheme of a preferred embodiment, retailers (or service providers) X and Y are members subscribed to the rewards scheme and members 1 and 2 are subscribed to the scheme as customer members. A retailer may use more than one electronic terminal (commonly known in Australia as Electronic Funds Transfer at Point of Sale terminals or “EFTPOS” terminals), for example if the retailer has several retail outlets. As an example, if member 1 uses its member card 1 to conduct transaction A, this transaction is associated with terminal 1 of Retailer X according to an Electronic Extract Report (EER). As member 1 and retailer X are both subscribed to the loyalty rewards scheme, transaction A is considered to constitute an “eligible transaction” for the purpose of determining whether that member is entitled to a cash rebate for that transaction. In the examples shown in FIG. 1, transaction B and transaction C are also considered to be eligible transactions for member 1 on member card 1, as each transaction was effected through a terminal corresponding to a subscribed retailer, namely retailer X.

On the other hand, while member card 3 belonging to member 2 is used to effect transactions H and I, only transaction I is made on a terminal associated with a subscribed retailer, and therefore transaction H is not an eligible transaction. Similarly, even though transaction F is effected using a terminal of a subscribed retailer, it is not effected with a card belonging to a subscribed member and therefore does not constitute an eligible transaction.

As shown in FIG. 1, it is possible for a subscribed member to have more than one member card. For example, the member may have multiple credit or debit cards issued by different banks or other card issuers and belonging to the same rewards scheme or, alternatively, the bank or card issuer may allow a spouse or child of the subscribed member to have an associated card which is also subscribed to the rewards scheme.

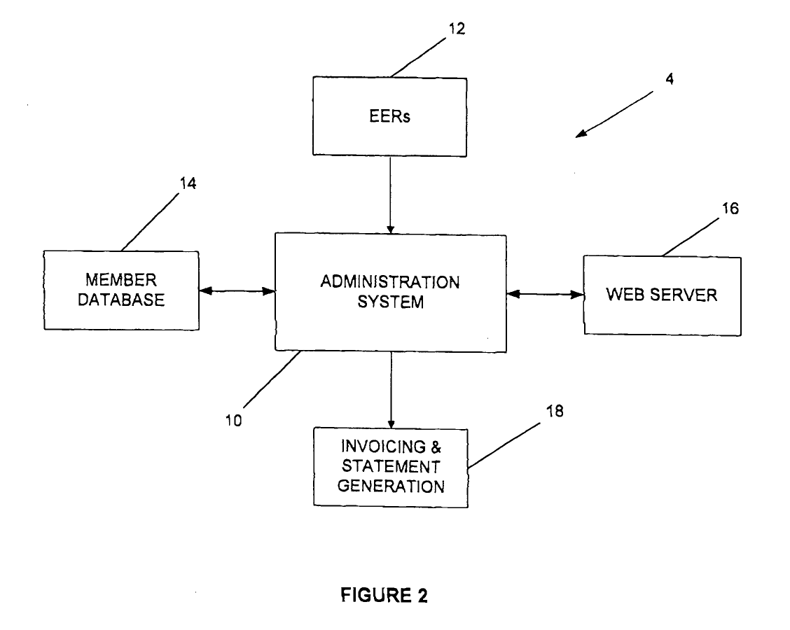

FIG. 2 shows a loyalty scheme system 4 having at its core an administration system 10. The method of administering a reward scheme as described herein is generally executed or facilitated by the loyalty scheme system 4. The administration system 10 performs most of the administration of the loyalty scheme, including receiving and processing EERs 12, communicating with and updating a customer and business member database 14 and outputting data for automatic invoice and statement generation 18. A web server 16 is also driven by the administration system 10 for enabling customer and business members to view and/or update their account details and apply for admission to the loyalty scheme. The web server 16 also facilitates advertising in favour of the business members (also called retailers or merchants) by providing a template into which they can put their desired advertising information

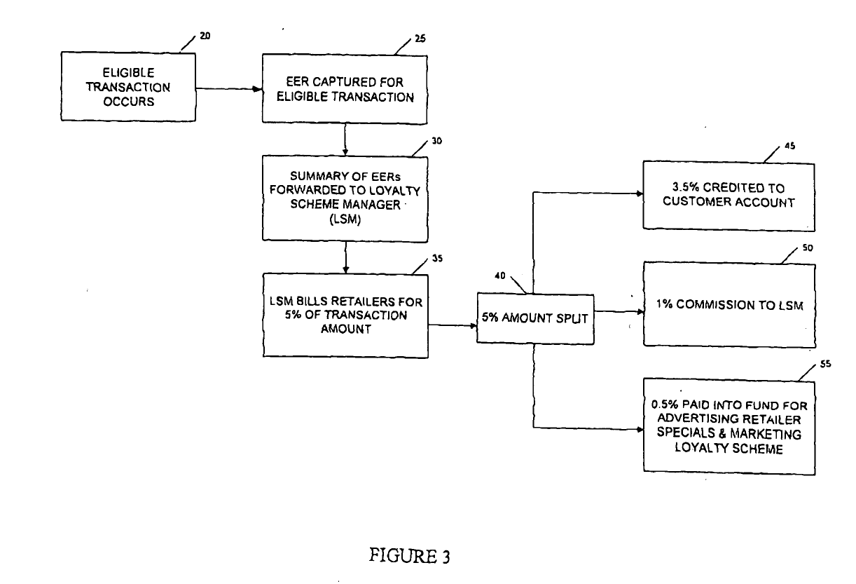

Referring now to FIG. 3, once an eligible transaction occurs at step 20, the Electronic Extract Report is captured for that eligible transaction at step 25. The EER is captured by a third party and is provided electronically to the administration system 10 of the rewards scheme (termed the “Loyalty Scheme Manager” in FIG. 3) at step 30. Each EER provided to the Loyalty Scheme Manager (LSM) relates to a particular transaction and only those EERs which relate to eligible transactions are captured and forwarded to the LSM. The third party performing the capturing step 25 holds sufficient unique identifying information to identify the card and/or account numbers of those customers, and the electronic transaction terminal numbers of those retailers, which are subscribed to the loyalty scheme. Each EER includes information such as the customer card and/or account number, electronic transaction terminal number, the date of the transaction and the cash amount of the transaction These EERs 12 are captured as soon as they occur but are only forwarded to the administration system 10 as a batch data output at periodical intervals, for example fortnightly or monthly.

The EERs 12 are preferably captured through a gateway associated with a credit or debit card issuer (such as a bank). The card issuer bank (providing the credit funds) is in communication with the bank providing the retailer EFTPOS terminal (and in fact these may be the same bank) at which the transaction is initiated, such that the gateway is in a position to store data relating to a transaction request originating from the retailer terminal and an authorisation (or lack thereof) signal transmitted back from the bank in response to the transaction request.

An example transaction may occur through the use of a magnetic strip card at an electronic terminal device at the point of sale (e.g. in a retail store). This is commonly effected by moving the card through a slot in the terminal device so that the device reads information encoded on the magnetic strip on the card. The purchaser commonly then enters an authorisation code, such as a PIN code, or the purchaser is presented with a signature slip for authorising the transaction. In this case, the card slotted into the terminal device is commonly directly associated with a bank debit or credit account and, once the transaction is authorised, the transaction amount is debited from the purchasers bank account. Alternatively, the transaction may be effected by payment of cash, cheque, card or other payment method supplemented by slotting a card into a terminal device owned by the administrator, where the card is not directly linked to the customer's bank account. In this case, the card slotted into the terminal device is a membership card only, but is readable by the terminal device in a similar manner as a bank magnetic strip card to give rise to a valid EER entry. The terminal device in this instance stores the transaction information and sends the captured transaction records in real-time or in a batch to the administrator system 10.

Once the LSM receives the EERs at step 30, the LSM the amount to bill each of the subscribed retailers bills the subscribed retailers for the eligible transactions to which they were a party. The retailers are billed a percentage of the cash value of the transaction and this percentage value is split into three portions at step 40. The percentage may differ, depending on the market or local conditions, for example from as low as 1% up to 20%. A preferred percentage is 5%, which is split so that 3.5% is credited to the customer's account at step 45, 1% is taken as a commission by the LSM at step 50 and the remaining 0.5% is put into a fiend for advertising in favour of the retailer at step 55. The proportional split chosen may, however, vary depending on the local commercial conditions advertising the fund is also used to market the loyalty scheme and such marketing may be done in conjunction with advertising for the retailer. This advertising fund feature is particularly advantageous to the retailer as it effectively provides valuable advertising without the retailer having to arrange the advertising itself.

The method shown in FIG. 3 is particularly suitable and effective where the LSM is directly associated with a periodical publication under which publishing masthead the advertising may be carried out. The method is suitable for both on-line (eg, web-based) publications and hard copy publications. Customers reading the periodic publication will see promotions of the subscribed retailers products and services and these retailers are shown as being subscribed to the loyalty scheme. The retailers are therefore the subject of advertising to the wider public as well as to those members of the loyalty scheme and are likely to receive increased sales as result,

In a preferred embodiment, the method allows for each of the retailers to input advertising or specials information into a web-based data capturing template via the web server 16, which is adapted to interface with the administration system 10 to automatically order and collate such information to facilitate advertising on behalf of those retailers. This information can be fed into advertising for both on-line and hardcopy publications.

Particular advantages of the loyalty reward scheme include the following:

1. The loyalty reward scheme of preferred embodiments offer a number of standard and additional features of loyalty programs combined with regular advertising in periodicals targeted to a specific geographic area, such as local community newspapers and radio. In this context, the invention is particularly suited to localised populations, for example numbering in the tens of thousands up to about, say, one hundred thousand. In a big city, the reward scheme can be gradually introduced from one localised population within the city to another.

2. The loyalty reward provided to the customer who shops at retailers subscribing to the scheme is generally redeemable as a direct monetary refund, for example in the form of a credit on the customer's bank account statement.

3. Another feature of the loyalty scheme is that participating business members are selected so as to provide customer members with a range of goods and services, but such that there is only a limited number of business members in each business category. For example, if there are four competing sporting goods stores in a locality, only one of those will be allowed to subscribe to the loyalty scheme. If there are twenty such merchants in the locality, then, for example, 3 to 5 of those may be allowed to join the reward scheme. As a general rule, no more than about 25% of businesses in a business category for each separate locality will be allowed to participate in the reward scheme. This gives the participating business members a degree of market exclusivity.

4. The present loyalty scheme advantageously encourages customer members to build loyalty to the program and to the merchant business members by allowing habit-forming (called habit loyalty). This is because a range of business members participate in the scheme, such that a customer member may do his or her weekly shopping by visiting a number of the business members, one after the other. For example, a customer member may visit a supermarket, pharmacy, sports store and movie rental store regularly If these stores are part of the loyalty reward scheme, then this builds habit loyalty, which has been found to be stronger than mere brand loyalty.

5. At least part of the advertising will be done in the local newspaper of the locality under which the members are subscribed. This may be a weekly newspaper, for example, and the advertising may comprise about six to eight tabloid pages per week, whereby the merchant's products, sales and weekly specials are advertised to the population at large and to the customer members of the loyalty scheme. This advertising may also be used to promote the loyalty scheme. Additional advertising may include radio and T.V. advertising to generate interest in the loyalty reward scheme and possibly for advertisement in favour of the business members of the scheme. Automatic e-mail or web-based advertising may be employed also.

It will be understood by those skilled in the art that some modifications and variations may be made to the described embodiments of the present invention while still remaining within the spirit and scope of the present invention.

1. A method of administering a rewards scheme, including the steps of:
receiving a plurality of Electronic Extract Reports (EERs) corresponding to a plurality of eligible transactions, each eligible transaction being a purchase transaction effected using an electronic transaction terminal between a business member of the rewards scheme and a customer member of the rewards scheme;
identifying from the EERs the business member and customer member party to each eligible transaction and a cash amount associated with the eligible transaction;
obtaining a credit from the business member for a predetermined percentage of the cash amount of each eligible transaction;
providing a first portion of the credit to the customer member party to the eligible transaction for which the credit was obtained; and
advertising in favour of the business member in a periodical publication associated with a confined geographic area, using a second portion of the credit.

2. The method of claim 1, further including the step of retaining a third portion of the credit as a commission payable to an administrator of the reward scheme.

3. The method of claim 2, wherein the proportions of the first, second, and third portions of the credit are about 7:1:2, respectively.

4. The method of claim 2 wherein the periodical publication is associated with the administrator.

5. The method of claim 1, wherein the periodical publication is a hard copy publication.

6. The method of claim 1, wherein the periodical publication is a publication available electronically.

7. The method of claim 1, wherein each business member is selected to have a specific degree of market exclusivity and/or a specific market territory.

8. The method of claim 1 wherein the confined geographic area is a county, shire, township or group of suburbs.

9. The method of claim 1, wherein each electronic transaction terminal has a unique business member identifier associated with a business member.

10. The method of claim 9, wherein a unique customer membership identifier is associated with a credit or debit account of each customer member, and wherein each EER includes the unique business member identifier and the unique customer membership identifier, the combination of which identities the purchase transaction as an eligible transaction.

11. The method of claim 4, wherein the steps of the method are carried out by the administrator or a system controlled by the administrator and the periodical publication associated with the administrator is directed to a population including customer members of the rewards scheme.

12. An administration system for a rewards scheme adapted to execute the method of claim 1.

13. Computer readable program instructions stored on one or more computer readable storage media, the program instructions, when executed, causing a computer system to perform the method of claim 1.
